(19) United States
(12) Patent Application Publication
(10) Pub. No.: US 2026/0180688 A1
(43) Pub. Date: Jun. 25, 2026

(54) DUAL-PROTOCOL OPTOELECTRONIC INTERFACE

(71) Applicant: SAGEMCOM BROADBAND SAS, BOIS-COLOMBES (FR)

(72) Inventors: Rodolphe DE BRAQUILANGES, BOIS-COLOMBES (FR); Jean-Philippe JAULIN, BOIS-COLOMBES (FR)

(21) Appl. No.: 19/426,955

(22) Filed: Dec. 19, 2025

(30) Foreign Application Priority Data
Dec. 20, 2024 (FR) FR2414911

(51) Int. Cl. H04B 10/60; G02B 5/28; G02B 6/293; H04B 10/03

(52) U.S. Cl. CPC H04B 10/60; G02B 5/288; G02B 6/293; H04B 10/03

(57) ABSTRACT

An optoelectronic interface includes a bandpass filter into which the incoming light signals are input and which is arranged to produce filtered light signals, the bandpass filter being configured to let through all the carrier signal wavelengths of the plurality of predefined communication protocols, a photoreceptor, and a processing unit arranged to select a specific software module associated with the specific communication protocol among a plurality of different software modules, each associated with one of the predefined communication protocols.

The invention relates to the field of optoelectronic interfaces.

### BACKGROUND

Known internet gateways are provided with a fibre optic communication interface intended to be connected to a passive optical network (PON).

PON fibre optic access networks are based on the transport of various information flows in a single optical fibre. These different information flows are generated and injected upstream and/or downstream of the access network by means of monochromatic laser sources and are differentiated by the wavelength of the light signals carrying the information of the flow to be transported.

G-PON access technology was deployed from around 2015, offering a rate of 2.5 Gbps in the downstream direction (from the core network to the user's terminal) and a rate of 1.25 Gbps in the upstream direction (from the user's terminal to the core network). Then, from 2020, XGS-PON access technology was added on certain networks, offering symmetrical rates of 10 Gbps and thus allowing operators to offer different performance levels to their customers.

The G-PON (Gigabit-capable passive optical network) access network defined by Recommendation ITU-T G.984.2 (“ITU-T G.984.2—Gigabit-capable passive optical networks (G-PON): Physical media dependent (PMD) layer specification”, International Telecommunication Union (ITU), Recommendation ITU-T G.984.2 Ed 2.0, September 2019) implements a flow in the downstream direction for which the wavelength of the carrier signal is 1490 nm, as well as a flow in the upstream direction for which the wavelength of the carrier signal is 1310 nm.

The XGS-PON access network (10-Gigabit-capable symmetric passive optical network) defined by Recommendation ITU-T G.9807.1 (ITU-TG.9807.1 (2016) Amd. 2, Edition 1.3, “10-Gigabit-capable symmetric passive optical network (XGS-PON)-Amendment 2”, International Telecommunication Union (ITU), Oct. 29, 2020) implements a flow in the downstream direction for which the wavelength of the carrier signal is 1577 nm, as well as a flow in the upstream direction for which the wavelength of the carrier signal is 1270 nm.

Recently, two new access networks have been defined by standardisation bodies and share an emerging market for very high-rate access networks.

The 25GS-PON (25-Gigabit symmetric passive optical network) access network defined by the 25GS-PON Specification from MSA GROUP (25GS-PON Specification, 3.0, “25GS-PON Specification—25 Gigabit Symmetric Passive Optical Network”, Nov. 2, 2023. [Online]. Available: www.25gspon-msa.org) implements a flow in the downstream direction for which the wavelength of the carrier signal is 1358 nm, as well as a flow in the upstream direction for which the wavelength of the carrier signal can assume three optional values.

The 50G-PON (50-Gigabit passive optical network) access network defined by standard ITU-T G.9804.3 (ITU-T G.9804.3 (2021) Amd. 2 (March 2024), Ed. 1.2, “50-Gigabit-capable passive optical networks (50GPON): Physical media dependent (PMD) layer specification, Amendment 2”, International Telecommunication Union (ITU), Mar. 22, 2024) implements a flow in the downstream direction for which the wavelength of the carrier signal is 1342 nm, as well as a flow in the upstream direction for which the wavelength of the carrier signal can assume the same three optional values.

These two new technologies share characteristics for their NRZ (non-return-to-zero) information modulation scheme and their rate in the upstream direction at 25 Gbps (Gigabits per second).

The key difference between these two access networks relates to the rate in the downstream direction—25 Gbps for 25GS-PON and 50 Gbps for 50G-PON—and the wavelengths of the carrier signals of these signals in the downstream direction.

One characteristic of these two access networks is that they are based on the use of upstream carrier signals that share the same optional wavelengths.

The three wavelength options for the upstream light signal make it possible to offer various solutions that can coexist with the earlier access technologies G-PON and XGS-PON.

The first variant, named UW0 for 25GS-PON and Option 1 for 50G-PON, uses an upstream carrier signal with a wavelength of 1270 nm, allowing it to coexist with a G-PON access network.

The second variant, named UW1 for 25GS-PON and Option 2 for 50G-PON, uses an upstream carrier signal with a wavelength of 1300 nm, allowing it to coexist with an XGS-PON access network.

The third variant, named UW3 for 25GS-PON and Option 3 for 50G-PON, uses an upstream carrier signal with a wavelength of 1286 nm, allowing it to coexist simultaneously with a G-PON access network and an XGS-PON access network.

The industry is focusing mainly on the third variant, which has the best coexistence coverage.

The two next-generation technologies are based on similar wavelengths to ensure that they can coexist with the upstream flows of the earlier generations, but they are in direct competition and are by no means intended to coexist on the same optical fibre distribution network.

Gateway manufacturers are therefore faced with the following problem.

The optoelectronic interface of their gateways connected to a network using 25GS-PON technology has to be capable of receiving light signals defined according to the 25GS-PON technology protocol, while the optoelectronic interface of its gateways connected to a network using 50G-PON technology has to be capable of receiving light signals defined according to the 50G-PON technology protocol.

Designing a single optoelectronic interface that is natively functional with either version of the new access technology would thus seem very advantageous.

In the context of PON optical fibre interfaces intended to operate with a plurality of optical access networks, it is known to use a QOSA (quadri-directional optical sub-assembly) suitable for both wavelength pairs of each protocol and to link it to two emit and receive amplification chains whose accesses to the processor are selected depending on a trigger component. However, a QOSA component of this kind is complex to produce and requires two complete communication chains to be implemented.

### Object

The object of the invention is to reduce the complexity and cost of an optoelectronic interface that is compatible with a plurality of communication protocols.

### SUMMARY

To achieve this object, an optoelectronic interface is proposed which is arranged to be connected to an optical fibre on which incoming light signals comprising specific light signals can travel, said specific light signals being defined according to a single specific communication protocol among a plurality of predefined communication protocols, each using a different carrier signal wavelength, the optoelectronic interface comprising:
a bandpass filter into which the incoming light signals are input and which is arranged to produce filtered light signals, the bandpass filter being configured to let through all the carrier signal wavelengths of the plurality of predefined communication protocols;
a photoreceptor arranged to produce incoming electrical signals from the filtered light signals;
a processing unit arranged to acquire the incoming electrical signals, to select a specific software module associated with the specific communication protocol among a plurality of different software modules, each associated with one of the predefined communication protocols, and to interpret the incoming electrical signals using said specific software module.

The bandpass filter is therefore configured to let through the specific light signals associated with all the predefined communication protocols. The processing unit then acquires the incoming electrical signals produced from the specific light signals and selects the specific software module associated with the specific communication protocol actually present on the network. The optoelectronic interface is therefore compatible with all the predefined communication protocols, meaning that the apparatus (a gateway, for example) can be connected to any network on which any one of these predefined communication protocols is used, even if the protocol used is not known at the time the gateway is designed and manufactured. The optoelectronic interface requires a single receive chain, thus simplifying the optoelectronic interface and reducing its design and manufacturing costs.

Also proposed is an optoelectronic interface as described above in which, to select the specific software module, the processing unit is arranged to:
use an initial software module among the plurality of different software modules when the optoelectronic interface is started up;
attempt to interpret the incoming electrical signals using the initial software module;
attempt to interpret the incoming electrical signals using another software module if the first attempt fails;
repeat these steps until the incoming electrical signals are interpreted using a suitable software module, the specific software module being said suitable software module.

Also proposed is an optoelectronic interface as described above in which the processing unit comprises a detection module arranged to analyse target signals from the incoming electrical signals and to produce a detection signal representative of the specific communication protocol of the specific light signals,
the processing unit being arranged to select the specific software module on the basis of the detection signal.

Also proposed is an optoelectronic interface as described above which further comprises a receive processing component that is connected to an output of the photoreceptor and that is arranged to produce a presence signal having a predefined value when a level of the filtered light signals received by the photoreceptor is greater than a predefined threshold, and in which the processing unit is arranged to select the specific software module on the basis of a combination of the detection signal and the presence signal.

Also proposed is an optoelectronic interface as described above in which the detection module comprises at least one detector arranged to detect an energy level of at least one predefined electrical frequency, each predefined electrical frequency being associated with one of the predefined communication protocols.

Also proposed is an optoelectronic interface as described above in which the detection module is arranged to perform a correlation operation among the target signals and one or more reference signals, each being associated with one of the predefined communication protocols.

Also proposed is an optoelectronic interface as described above in which a response curve of the bandpass filter comprises, for each carrier signal wavelength associated with a predefined communication protocol, a local maximum covering said carrier signal wavelength.

Also proposed is an optoelectronic interface as described above in which the response curve comprises, between two successive local maxima, a substantially constant portion having an amplitude substantially equal to that of the local maxima.

Also proposed is an optoelectronic interface as described above which further comprises a light source arranged to emit outgoing light signals on the optical fibre, a coupling element, and a beam splitter positioned between the optical fibre on the one hand, and the light source and the photoreceptor on the other hand, the light source, the photoreceptor, the coupling element, the beam splitter and the bandpass filter being integrated in the same optoelectronic component.

Also proposed is an optoelectronic interface as described above which further comprises a light source arranged to emit outgoing light signals on the optical fibre, a coupling element, and a beam splitter positioned between the optical fibre on the one hand, and the light source and the photoreceptor on the other hand, the light source, the photoreceptor, the coupling element and the beam splitter being integrated in the same optoelectronic component, the optoelectronic interface further comprising a Bragg grating, which forms the bandpass filter, and an insulator, the Bragg grating and the insulator being located outside and upstream of said optoelectronic component.

Also proposed is an apparatus including an optoelectronic interface as described above.

Also proposed is an apparatus as described above in which the apparatus is an internet gateway arranged to be connected to a PON.

Also proposed is a configuration method which is carried out in a processing unit of an optoelectronic interface as described above and comprises the steps of acquiring the incoming electrical signals, of selecting a specific software module associated with the specific communication protocol among a plurality of different software modules, each associated with one of the predefined communication protocols, and of interpreting the incoming electrical signals using said specific software module.

Also proposed is a computer program comprising instructions which cause the processing unit of the optoelectronic interface as described above to execute the steps of the configuration method as described above.

Also proposed is a computer-readable storage medium on which the computer program as described above is stored.

The invention will be better understood in the light of the following description of particular, non-limiting embodiments of the invention.

### BRIEF DESCRIPTION OF THE DRAWINGS

Reference will be made to the accompanying drawings, in which:

FIG. 1 shows a gateway comprising an optoelectronic interface according to a first embodiment;

FIG. 2 shows an optoelectronic sub-assembly;

FIG. 3 shows a response curve of a bandpass filter according to a first embodiment;

FIG. 4 shows a response curve of a bandpass filter according to a second embodiment;

FIG. 5 shows a gateway comprising an optoelectronic interface according to a second embodiment;

FIG. 6 shows the steps of a configuration method carried out in the gateway.

### DETAILED DESCRIPTION

In the following description, identical, similar or analogous elements will be denoted by the same reference signs.

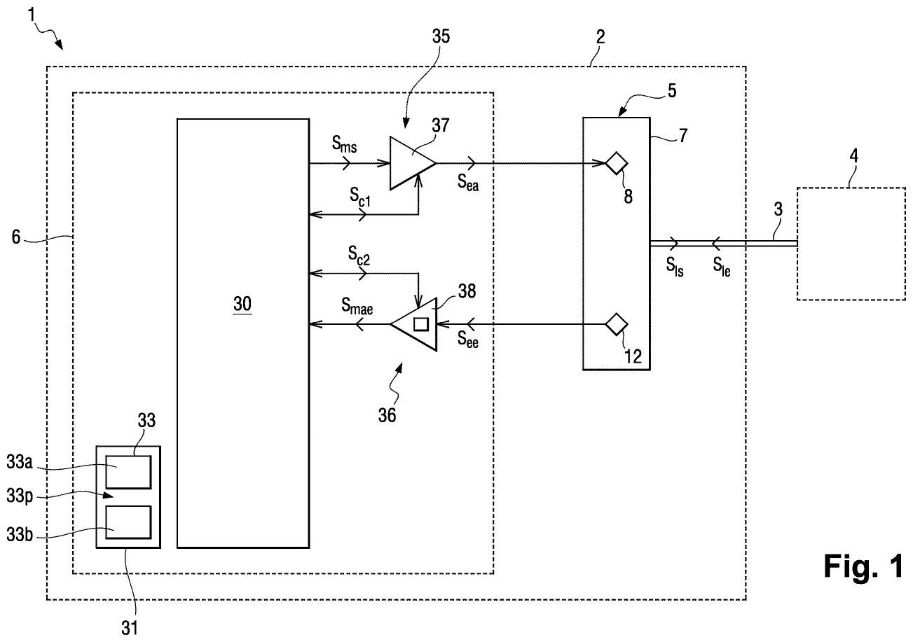

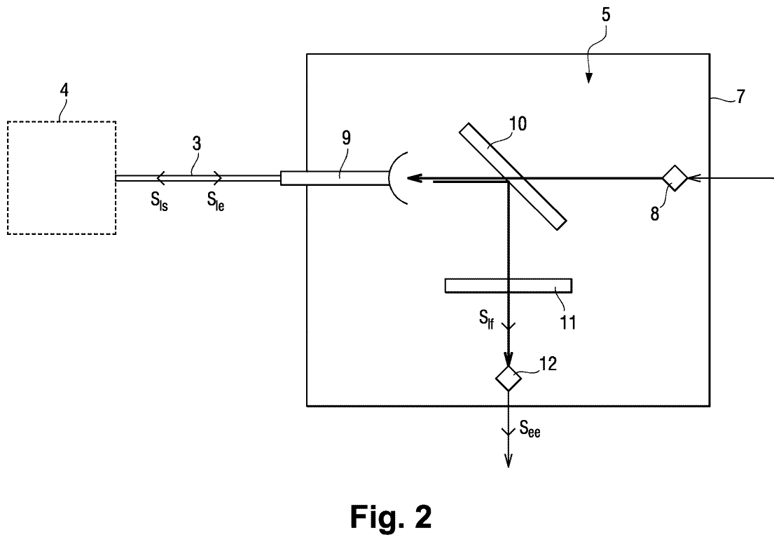

With reference to FIGS. 1 and 2, the internet gateway 1 comprises an optoelectronic interface 2 according to a first embodiment. This optoelectronic interface 2 is connected to an optical fibre 3 of a PON 4.

The optoelectronic interface 2 allows the gateway 1 to transmit outgoing light signals Sₗₛ to the network (“upstream” communication) and to receive incoming light signals Sₗₑ from the network 4 (“downstream” communication).

The incoming light signals Sₗₑ, which originate from the network 4 and travel on the optical fibre 3, comprise specific light signals Sₗₚ which are each defined according to a single specific communication protocol among a plurality of predefined communication protocols. The incoming light signals Sₗₑ may therefore comprise:
either only the specific light signals Sₗₚ,
or the specific light signals Sₗₚ and other light signals that are not defined according to one of the predefined communication protocols.

Here, the plurality of predefined communication protocols includes two possible protocols: that associated with 25GS-PON access network technology and that associated with 50G-PON access network technology.

The design of the gateway 1 allows it to interact with any one of these two protocols; it is noted again that these two protocols are in competition and only one is present on the network 4. The specific communication protocol actually present on the optical fibre 3 is not known at the time the gateway 1 is designed and manufactured.

The optoelectronic interface 2 comprises an optoelectronic sub-assembly 5 and a processing unit 6.

The optoelectronic sub-assembly 5 is bidirectional and, in this case, is integrated in a single optoelectronic component 7 of the BOSA type (bidirectional optical sub-assembly).

The optoelectronic sub-assembly 5 comprises an emitting device comprising a light source 8, a coupling element 9, a beam splitter 10, a bandpass filter 11 and a receive device comprising a photoreceptor 12.

The coupling element 9 and the beam splitter 10 are positioned between the optical fibre 3 (upstream side) on the one hand, and the light source 8 and the photoreceptor 12 (downstream side) on the other hand.

Here, the light source 8 is for example a laser source, for example a laser diode. The laser diode 8 emits the outgoing light signals Sₗₛ towards the optical fibre 3 in the form of monochromatic optical signals. The outgoing light signals Sₗₛ are emitted by the laser diode 8 on the optical fibre 3 via the beam splitter 10 and the coupling element 9.

The coupling element 9 is:
suitable for transmitting the outgoing light signals Sₗₛ received from the laser diode 8 in an aerial propagation space towards the core of the optical fibre 3 so that they are directed in the upstream direction of the optical network 4; and
suitable for transmitting, towards an aerial propagation space, the incoming light signals Sₗₑ from the core of the optical fibre 3, which originate from the upstream direction of the optical network 4.

The beam splitter 10 is oriented such that its reflective face can direct the incoming light signals Sₗₛ received from the coupling element 9 towards the sensor surface of the photoreceptor 12, and such that its absorbing face can let the outgoing light signals Sₗₛ generated by the laser diode 8 pass through towards the coupling element 9.

The incoming light signals Sₗₑ are input into the bandpass filter 11 via the coupling element 9 and the beam splitter 10.

The bandpass filter 11 produces filtered light signals S_{lf} from the incoming light signals Sₗₑ.

The photoreceptor 12 of the receive device comprises a photodiode. The photodiode 12 receives the filtered light signals S_{lf} and generates incoming electrical signals Sₑₑ, which resemble the filtered light signals S_{lf} received by the photodiode.

Since a photodiode is by nature almost agnostic to the energy of the photons that strike it, and therefore to the wavelength of the light signal received from the upstream direction of the optical network, it is customary to insert a filter, such as the filter 11, into the optical receive path. This measure makes it possible to select an optical signal among a plurality of signals potentially present on the optical network.

By way of example, the BOSA component used is the BOSA model PB630005 from POTRON (registered trademark), which allows a 50G-PON access network to be interfaced. This component is composed of:
a laser source suitable for emitting, at a rate of 25 Gbps, a monochromatic light signal with a wavelength of 1286 nm, corresponding to option 3 of the 50G-PON technology and option UW3 of 25GS-PON;
a photoreceptor suitable for receiving, at a maximum rate of 50 Gbps, a light signal in the O and E bands of infrared signals (1260-1460 nm);
a receive bandpass filter whose passband covers the 1330-1356 nm wavelength range defined by Recommendation ITU-T G.9804.3 in chapter 10.1.

Here, however, as has been noted, the gateway 1 is likely to receive specific light signals Sₗₚ that are defined according to a single specific communication protocol (which is not known a priori) among a plurality of predefined communication protocols, each using a different carrier signal wavelength.

The incoming light signals Sₗₑ comprising the specific light signals Sₗₚ are therefore input into the bandpass filter 11.

Here, the original BOSA component has been modified. The bandpass filter 11 has been modified and is now suitable for letting through all the carrier signal wavelengths of the plurality of predefined communication protocols. In this case, therefore, the bandpass filter 11 is configured to let through the wavelengths 1342 nm and 1358 nm.

The idea was thus to adapt the original BOSA component to also function with the 25GS-PON technology by modifying the passband of the filter 11 so that it also lets through the downstream light signals of the 25GS-PON technology, whose wavelength is 1258 nm as defined in the MSA GROUP 25GS-PON Specification in Figure B.1.

This modification can be done using a method known to a person skilled in the art in the field of optical filtering, by adjusting the composition and structure of the thin layers deposited on the surface of the glass plate forming the bandpass filter 11.

Advantageously, the passband of the filter 11 should cover the 1330-1380 nm wavelength range so that the photodiode 12 is responsive to the optical signals received from upstream for both technologies.

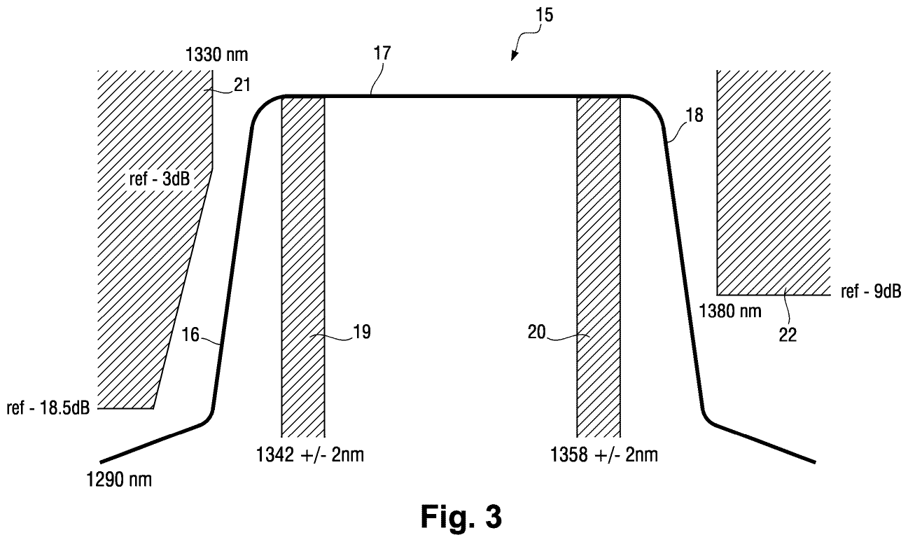

With reference to FIG. 3, the response curve 25 of the bandpass filter 11 comprises, for each carrier signal wavelength associated with a predefined communication protocol, a local maximum 26a, 26b covering said carrier signal wavelength.

The response curve 25 of the bandpass filter 11 therefore comprises a first local maximum 26a covering the band 1342+/−2 nm and a second local maximum 26b covering the band 1358+/−2 nm.

This bandpass filter makes it possible to ensure receive compatibility with the optical signals in the downstream direction of the 25GS-PON and 50G-PON technologies.

The mask 19 shows a first passband covering the downstream signal band of the 50G-PON technology, for which the filter has to exhibit a minimum reference attenuation. This attenuation, corresponding to the substantially constant portion, is ideally equal to a few tenths of a dB.

The mask 20 shows a second passband covering the downstream signal band of the 25GS-PON technology, for which the filter likewise has to exhibit a minimum reference attenuation.

The substantially constant portion 17 of the response curve therefore covers all the carrier signal wavelengths of all the predefined communication protocols: here the 1342+/−2 nm band and the 1358+/−2 nm band.

The mask 21 shows the minimum wavelength and attenuation boundary that the filter 11 has to apply to the signal passing through it for the lower part of the spectrum. Here, this boundary corresponds to the lower boundary shown by Recommendation ITU-T G.9804.3 in chapter 10.1.

The mask 22 shows the minimum wavelength and attenuation boundary that the filter 11 has to apply to the signal passing through it for the upper part of the spectrum. Here, this boundary corresponds to the upper boundary shown in the MSA GROUP 25GS-PON Specification in Figure B.1.

The response curve 25 of the filter complies with the specification of the masks 19, 20, 21 and 22.

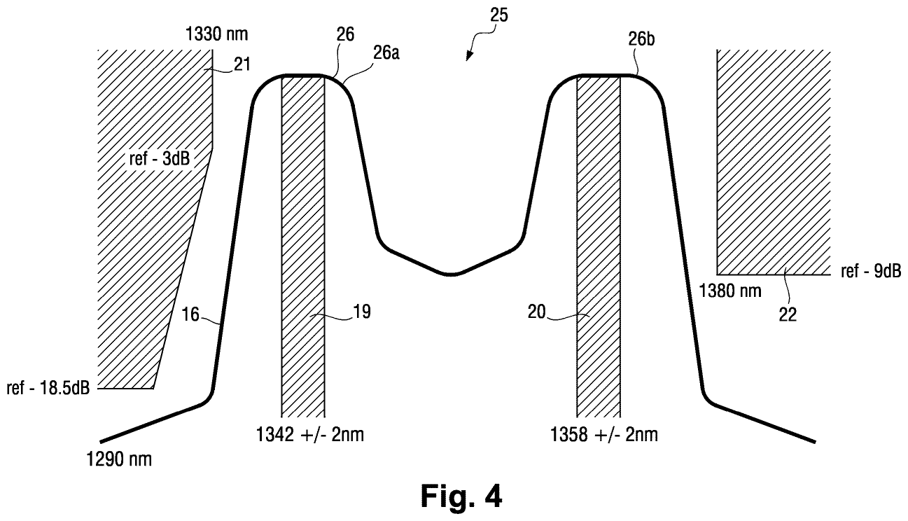

With reference to FIG. 4, the response curve 15 of the filter 11 according to a second embodiment comprises, between two successive local maxima, a substantially constant portion 17 having an amplitude substantially equal to that of the local maxima.

The response curve 15 therefore comprises a rising portion 16, followed by the substantially constant portion 17, followed by a falling portion 18.

The response curve 15 of the filter 11 again complies with the specification of the masks 19, 20, 21 and 22.

The bandpass filtering principle described herein in the context of the 25GS-PON and 50G-PON protocols can be transposed to any other pair or set of protocols for which it would be advantageous to share the photoreceptor. In this case, it is necessary to define the passband(s) for letting light signals that correspond to each of the protocols pass through in the downstream direction while blocking unwanted signals.

In this case, as set out above, the light source 8, the photoreceptor 12, the coupling element 9, the beam splitter 10 and the bandpass filter 11 are integrated in a single optoelectronic component 7. This configuration is not mandatory.

For example, the bandpass filter 11 could be shifted outside the optoelectronic component 7, which then includes only the light source 8, the photoreceptor 12, the coupling element 9 and the beam splitter 10.

In that case, the bandpass filter 11 is located upstream of the optoelectronic component 7, in series on the optical fibre 3.

This configuration makes the implementation more complex as it requires an additional component. Specifically, the filter, as placed in front of the photoreceptor in FIG. 2, makes it possible to naturally block the photons that are transmitted by the laser diode 8 and that would be reflected by an element of the access network. This blocking function is very important to avoid disrupting the photodiode 12, which is responsive to a very broad spectrum.

If the bandpass filter 11 had to be placed outside the component 7, it would also have to let the outgoing light signals Sₗₛ produced by the laser diode 8 pass through in the upstream direction while blocking their possible reflections from upstream.

In this configuration, the bandpass filter 11 comprises a Bragg grating, for example. The optoelectronic interface 2 further comprises an optical insulator for blocking parasitic signals resulting from reflections of the outgoing light signals. The Bragg grating and the insulator are located outside and upstream of the optoelectronic component 7.

The processing unit 6 (electronic and software) comprises at least one processing component 30, for example, a “general-purpose” processor, a processor specialising in signal processing (digital signal processor, DSP), a processor specialising in artificial intelligence algorithms (neural processing unit, NPU), a microcontroller, or a programmable logic circuit such as an FPGA (field-programmable gate array) or an ASIC (application-specific integrated circuit).

In this case, the processing component 30 is a processor referred to as the “main processor”.

The processing unit 6 also comprises one or more memories 31 connected to or integrated in the processing component 30. At least one of these memories 31 forms a computer-readable storage medium on which at least one computer program is stored, said computer program comprising instructions which cause the processing component 30 to execute at least some steps of the configuration method described below.

The main processor 30 is responsible for generating and decoding the electrical signals implemented in the optoelectronic interface 2. It is also responsible for executing the software needed to implement this interface and, in particular, is responsible for the protocol aspect depending on the access network technology selected.

A plurality of different software modules 33, each responsible for a different predefined communication protocol, are stored in the memory 31 and are capable of being executed by the main processor 30. Each software module 33 is therefore associated with a single, separate predefined communication protocol and is capable of interpreting (only) the incoming electrical signals Sₑₑ from the specific light signals Sₗₚ defined according to said different predefined communication protocol.

Here, therefore, there are at least two software modules stored in the memory 31: one software module 33a associated with the 25GS-PON technology protocol and one software module 33b associated with the 50G-PON technology protocol.

The processing unit 6 further comprises a (single) emit chain 35 and a (single) receive chain 36.

The emit chain 35 comprises a laser driver component 37, which comprises an adjustable amplifier and is connected to the laser diode 8. Here, the laser driver component 37 is located outside the optoelectronic component 5.

Thus, in the upstream direction, the software module responsible for implementing the interface with the access network defines a set of outgoing digital signals Sₙₛ that are generated by a specific electrical interface of the processor 30 in order to be converted into outgoing light signals Sₗₛ to be routed in the upstream direction of the access network. These outgoing digital signals Sₙₛ are shaped by the laser driver component 37, which is controlled by the processor 30 by means of control signals S_{c1}. The analogue electrical signals Sₑₐ shaped by the laser driver component 37 are injected into the laser diode 8 integrated in the optoelectronic component 7 (BOSA) in order to be converted so as to produce the outgoing light signals Sₗₛ which are transmitted upstream through the optical fibre 3.

In the downstream direction, the incoming electrical signals Sₑₑ, which resemble the specific light signals Sₗₚ received from upstream, are generated by the photodiode 12 integrated in the optoelectronic component 7. These incoming electrical signals Sₑₑ, which are analogue electrical signals, are converted into a set of incoming digital signals Sₙₑ by a receive processing component 38 of the receive chain 36, said component being connected to an output of the photodiode 12. The receive processing component 38 comprises an adjustable shaping amplifier controlled by the processor 30 by means of control signals S_{c2}. The incoming digital signals Sₙₑ shaped by the receive processing component 38 are injected into a specific electrical interface of the main processor 30 in order to be processed therein and interpreted by the software module.

One example of a laser driver component is the model MALD-37035B from MACOM (registered trademark).

One example of a receive processing component is the model MATP-056026 from MACOM.

One example of a main processor component is the model BCM55050 from BROADCOM (registered trademark).

In an alternative implementation, it is conceivable for the laser driver and the receive processor to be grouped in a single component, for example the model GN27L90 from SEMTECH (registered trademark).

It is also conceivable for the receive processing component and/or the laser driver component to be integrated in the processor.

The optoelectronic interface 2 thus comprises a single emit chain 35 and a single receive chain 36.

As set out above, the bandpass filter 11 lets through all the carrier signal wavelengths of the plurality of predefined communication protocols, i.e. in this case the wavelengths of the 25GS-PON technology protocol and the 50G-PON technology protocol.

The optoelectronic interface 2 thus allows the gateway 1 to function according to either access network technology.

As set out above, one of the technologies is present on the network 4, and this technology is not known a priori by the gateway 1, which is configured to be able to work with both technologies. However, to work correctly, the gateway 1 has to use a software module 33 that is responsible for the protocol and suitable for the specific communication protocol of the specific light signals Sₗₚ.

This software module is implemented by the processing component 30 and in particular allows the incoming electrical signals Sₑₑ to be interpreted.

The processing unit 6 is arranged to acquire the incoming electrical signals Sₑₑ, to select a specific software module 33p associated with the specific communication protocol among the plurality of different software modules 33, and to interpret the incoming electrical signals Sₑₑ using said specific software module 33p.

In a first embodiment, to select the specific software module 33p, the processing unit 6 is arranged to:
use an initial software module (for example the software module 33a) when the gateway 1 and therefore the optoelectronic interface 2 is started up;
attempt to interpret the incoming electrical signals Sₑₑ using the initial software module;
attempt to interpret the incoming electrical signals Sₑₑ using another software module (the software module 33b in this case) if the first attempt fails;
repeat these steps until the incoming electrical signals are interpreted using a suitable software module, the specific software module 33p being said suitable software module.

In this embodiment, the software configuration is therefore predefined to be executed automatically when the gateway 1 is started up. It may also be initiated by a subsequent configuration action followed by a restart of the gateway 1.

By default, when the gateway 1 is manufactured, the initial software module responsible for the protocol is, for example, associated with the protocol of the 25GS-PON technology (module 33a).

Therefore, as soon as the processing unit 6 receives the incoming electrical signals Sₑₑ originating from specific light signals Sₗₚ, it attempts to interpret them using this software module.

If this is successful, the software module associated with the 25GS-PON technology protocol is retained and therefore selected. The incoming electrical signals are interpreted using this specific software module.

If this attempt fails, the software module associated with the 50G-PON technology protocol is selected (software module 33b) and then loaded and executed.

It goes without saying that the initial software module responsible for the protocol could be that associated with the 50G-PON technology protocol.

However, this operation requires the gateway 1 to be restarted, which is restrictive.

It is also conceivable to place the management of the software module 33 responsible for the protocol on standby when the gateway 1 is started up, and then to launch a specific version depending on a subsequent action. This alternative advantageously makes it possible to avoid having to restart the entire gateway 1 due to an initial selection being incompatible with the technology of the access network 4 connected to the interface 2.

To take advantage of this alternative, the presence of one access network technology or the other on the fibre 3 should be detected as soon as the fibre is connected to the optoelectronic interface 2.

Since the photodiode 12 is indiscriminately responsive to the specific light signals Sₗₚ originating from one type of access network or the other, it is expedient to use other signals to maintain the distinction and therefore detect the presence of one protocol or the other.

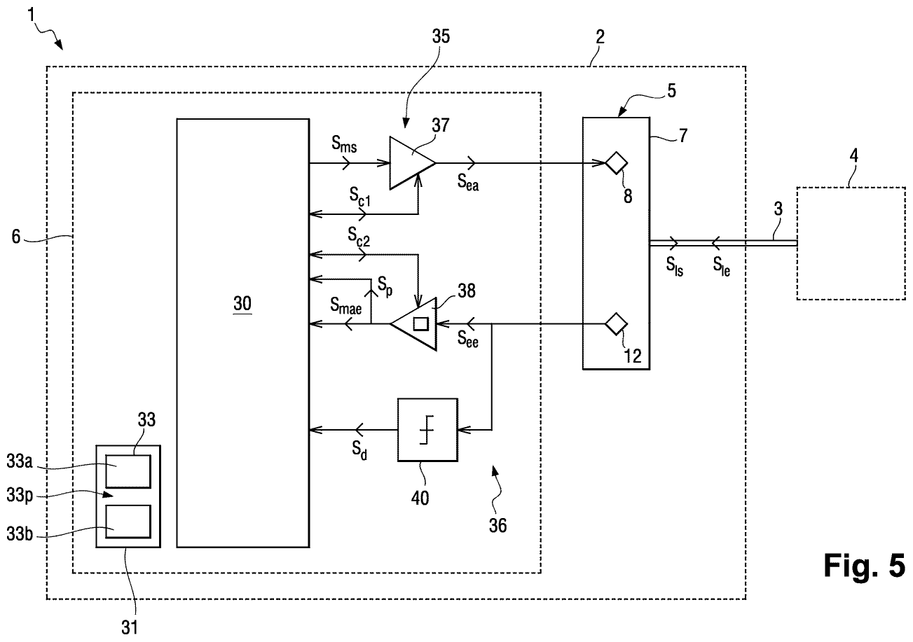

In a second embodiment, with reference to FIG. 5, the processing unit 6 comprises a detection module 40 arranged to analyse target signals from the incoming electrical signals Sₑₑ and to produce a detection signal S_{d} representative of the specific communication protocol of the specific light signals Sₗₚ, the processing unit 6 being arranged to select the specific software module 33p on the basis of the detection signal S_{d}.

By way of example, the target signals are the incoming electrical signals Sₑₑ themselves or the incoming digital signals Sₙₑ. Here, the detection module 40 is connected to the photodiode 12 and the target signals are the incoming electrical signals Sₑₑ.

In this case, “analyse the target signals” means:
acquiring the target signals;
extracting at least one predefined characteristic of the target signals that is representative of the specific communication protocol of the specific light signals Sₗₚ from which the target signals originate.

The “analysis” can thus be performed on incoming analogue or digital electrical signals.

Moreover, the receive processing component 38 is in this case arranged to produce a presence signal Sₚ having a predefined value when a level of the filtered light signals S_{lf} that are received by the photodiode 12 is greater than a first predefined threshold. The first predefined threshold is, for example, equal to −30 dBm. The presence signal Sₚ therefore makes it possible to detect the presence of specific light signals Sₗₚ whose carrier signal wavelength is included in the transmission band of the bandpass filter 11.

In one embodiment, the processing unit 6 is configured to select the specific software module 33p on the basis of a combination of the detection signal S_{d} and the presence signal Sₚ.

For example, the presence signal Sₚ here is the LOS (Loss of Signal) protocol signal. A first level of directly processable information exists in the form of the LOS protocol signal produced by the receive processing component. This digital LOS signal is placed in an active state as soon as no optical signal having a predefined and sufficient level is received by the photodiode 12, and therefore as soon as a level of the filtered light signals S_{lf} received by the photodiode 12 is less than a second predefined threshold. The second predefined threshold is, for example, equal to −35 dBm.

The same first level of directly processable information also exists in the form of the RX_SD (Reception Signal Detect) protocol signal produced by the receive processing component 38. This digital RX_SD signal is placed in an active state as soon as an optical signal having a sufficient predefined level is received by the photodiode 12.

Either of the LOS or RX_SD signals, or a combination of the two, can be used to ensure that the main processor 30 detects specific light signals Sₗₚ that are received by the photodiode 12 and whose wavelength corresponds to the passband of the bandpass filter 11.

The two access network technologies are distinguished in the downstream direction by the raw speed of the received signal, and therefore by the frequency signature of the electrical signal at the output of the photodiode 12 or at the output of the receive processing component 38, depending on whether the analogue signal or the digital signal is being considered.

The 25GS-PON technology implements an NRZ-modulated downstream signal that is clocked at the rate of 25 Giga symbols per second. This signal at the output of the photodiode 12, converted into the electrical domain by the photodiode 12, or at the output of the receive processing component 38 after having been reshaped and normalised, therefore has a spectral signature extending from the low frequencies up to 12.5 GHz for the useful signal. Harmonics related to the sharpness of the fronts are also present beyond this, but their energy level is not significant.

The 50G-PON technology implements an NRZ-modulated downstream signal that is clocked at the rate of 50 Giga symbols per second. This signal at the output of the photodiode 12, converted into the electrical domain by the photodiode 12, or at the output of the receive processing component 38 after having been reshaped and normalised, therefore has a spectral signature extending from the low frequencies up to 25 GHz for the useful signal. Harmonics related to the sharpness of the fronts are also present beyond this, but their energy level is not significant.

In a first alternative, the detection module 40 comprises at least one detector arranged to detect an energy level of at least one predefined electrical frequency, each predefined electrical frequency being associated with one of the predefined communication protocols.

In this case, the radiofrequency detector 40 has a central frequency defined at 25 GHz for a bandwidth of about 10 GHz.

The incoming electrical signals Sₑₑ from the photodiode 12, which are thus analogue signals, are input into the radiofrequency detector 40 (and therefore into its radiofrequency part).

The radiofrequency detector 40 produces a (digital) detection signal S_{d} which is representative of an energy level present in the incoming electrical signals Sₑₑ and which is related to whether or not a signal clocked at the rate of 50 Giga symbols per second is present.

The digital output of the detection module 40 is connected to a digital input of the processor 30. The processor can evaluate the presence of the signature showing the presence of a downstream signal of the 50G-PON technology. It is noted that the detection module 40 can be integrated in the receive processing component 38 or the processor 30 or can be in the form of a separate module (as in FIG. 5) that acquires the incoming electrical signals Sₑₑ at the output of the photodiode 12 or at the output of the receive processing component 38.

Alternatively, the detection module is arranged to perform a correlation operation among the target signals and one or more reference signals, each being associated with one of the predefined communication protocols.

The digital output of the detection module is again connected to a digital input of the processor.

The correlation operation can thus be carried out among the target signals (which are, for example, the “real” incoming analogue electrical signals or the incoming digital signals Sₙₑ) and one or more typical reference signals which would be present at the same place in the event of receipt of a downstream signal according to at least one of the possible technologies.

Here, the reference signal corresponds to the 50G-PON technology.

Again, the detection module 40 can be integrated in the receive processing component 38 or the processor 30 or can be in the form of a separate module (as in FIG. 5) that acquires the incoming electrical signals Sₑₑ at the output of the photodiode 12 or at the output of the receive processing component 38.

Once the specific communication protocol of the specific light signals Sₗₚ has been detected, the processing unit 6 loads and executes the specific “correct” software module 33p that matches the specific light signals Sₗₚ actually present. There is therefore no need to restart the gateway 1.

Owing to a combination of the information available to the processor 30, such as the LOS signal present on the signals from the receive processing component 38 and the signals from the detection module 40, it is thus possible to determine the presence of a signal showing a very high-rate access network connected to the optoelectronic interface.

The table in the Appendix shows an example of how these two signals can be used to determine whether none, one or both of the access network technologies are present on the fibre 3 connected to the interface 2.

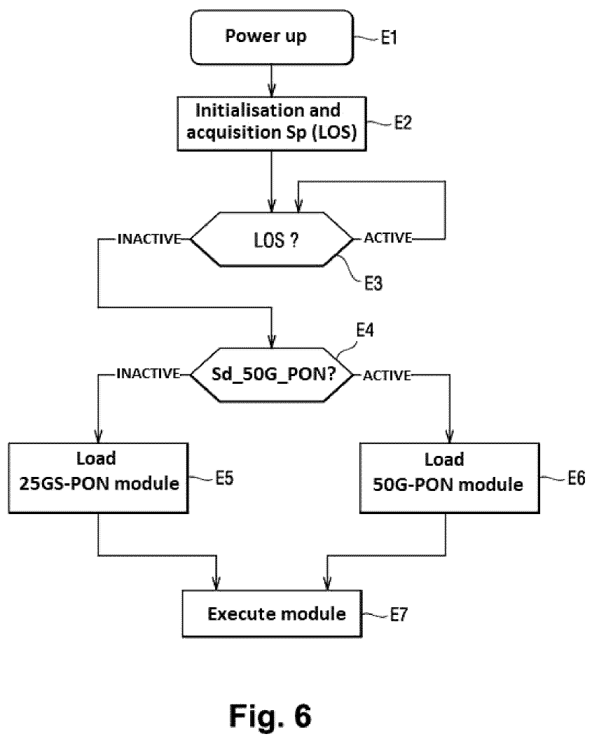

With reference to FIG. 6, a specific embodiment of the configuration method carried out by the processing unit 6 (use of the presence signal Sₚ, in this case the LOS signal, and of the detection module 40, using the radiofrequency detection technique for a signature of the 50G-PON technology) is described.

The gateway 1 is powered up: step E1.

The processor 30 initialises the receive chain 36 and in particular the receive processing component 38 so that it activates at least its LOS signal (Sₚ) detection function: step E2. The processing unit 6 acquires the presence signal Sₚ.

The processor 30 then waits for the deactivation of the LOS signal resulting from there being a sufficient downstream optical signal level at the input to the interface in a band encompassing the 25GS-PON and 50G-PON technologies: step E3. The processing unit 6 acquires the incoming electrical signals Sₑₑ.

As soon as this signal has been detected, the processor 30 is able to detect, by means of the detection signal Sa, whether or not the signature of a downstream signal corresponding to the 50G-PON technology is present: step E4.

As soon as this signal is inactive, the processor 30 can then load the software module 33a for the protocol-related and physical management of a 25GS-PON access interface: step E5.

Otherwise, the processor 30 loads the software module 33b for the protocol-related and physical management of a 50G-PON access interface: step E6.

The processor 30 has thus selected and loaded the specific software module associated with the specific communication protocol.

After having loaded the specific software module 33p for the detected technology, the processor 30 can initiate the execution thereof and thus start its mechanism for synchronising with the selected access network: step E7. The processor 30 interprets the incoming electrical signals using the specific software module.

Thus, according to one or more embodiments, modifying the passband of the bandpass filter and selecting a specific software module associated with the specific communication protocol make it possible, during the gateway initialisation phase, to determine, on receipt of a downstream signal, whether the gateway should be configured according to a 50G-PON access or a 25GS-PON access. This thus provides a low-cost solution for enabling the gateway to effectively detect which type of access is to be used.

It is noted that the optoelectronic interface is particularly advantageous since the outgoing light signals use the same wavelength (thus allowing a single laser diode to be used for both protocols).

It goes without saying that the invention is not limited to the described embodiments but covers any variant falling under the scope of the invention as defined by the claims.

The apparatus in which the optoelectronic interface is integrated is not necessarily an internet gateway. It could also be a simple ONU (optical network unit) responsible for converting the optical signals and processing them according to one of the protocols present on the optical network towards a higher-level protocol such as IP (Internet Protocol) so that they can be used in a third-party apparatus such as an internet router or an internet gateway. The connection between these two ONU and router devices can be in the form of an Ethernet link, for example.

The optoelectronic component, which includes the optoelectronic sub-assembly at least in part, is not necessarily a BOSA component. There are other assemblies available, such as a QOSA (quadri-directional optical sub-assembly) or TriOSA (triple optical sub-assembly). These components, which can be used to produce the optoelectronic sub-assembly at least in part, are derived from the main structure of the BOSA as described and comprise a plurality of emitting sub-assemblies that are suitable for as many monochromatic light signals as can coexist in the same optical network, and/or a plurality of receive sub-assemblies that are also suitable, by virtue of different filters, for as many such monochromatic light signals.

The number of predefined communication protocols likely to be present on the network could be different from two.

The optoelectronic interface is able to work with all types of PON protocols as long as the incoming light signals Sₗₑ are likely to be in the passband of the bandpass filter 11. In one or more embodiments, a plurality of predefined communication protocols are likely to be present on the optical fibre, this plurality comprising N protocols where N≥2. The detection module is configured to detect a subset of the plurality of protocols, this subset comprising N−1 protocols of the plurality of protocols, the detection module further being configured to process the signal Sp as an indication that a protocol (referred to as the “last protocol”) not belonging to said subset has been detected. In one example, the detection module detects the last protocol by interpreting the LOS to mean that the last frequency of said last protocol has been detected.

In one or more embodiments, the bandpass filter 11 is modified to be bandpass for the operating frequencies of the plurality of N predefined communication protocols. In one example, the different masks of the bandpass filter 11 are adapted to the bandwidths of the N predefined protocols.

APPENDIX

| | | State of the very high-rate |
|---|---|---|
| Signal Sₚ | Signal S_{d} | network |
| ACTIVE | INACTIVE | Not present |
| INACTIVE | INACTIVE | 25GS-PON present |
| INACTIVE | ACTIVE | 50G-PON present |

1. An optoelectronic interface (2) arranged to be connected to an optical fibre on which incoming light signals comprising specific light signals can travel, said specific light signals being defined according to a single specific communication protocol among a plurality of predefined communication protocols, each using a different carrier signal wavelength, the optoelectronic interface comprising:
a bandpass filter into which the incoming light signals are input and which is arranged to produce filtered light signals, the bandpass filter being configured to let through all the carrier signal wavelengths of the plurality of predefined communication protocols;
a photoreceptor arranged to produce incoming electrical signals from the filtered light signals; and
a processing unit arranged to acquire the incoming electrical signals, to select a specific software module associated with the specific communication protocol among a plurality of different software modules, each associated with one of the predefined communication protocols, and to interpret the incoming electrical signals using said specific software module.

2. The optoelectronic interface according to claim 1, wherein, to select the specific software module, the processing unit is arranged to:
use an initial software module among the plurality of different software modules when the optoelectronic interface is started up;
attempt to interpret the incoming electrical signals using the initial software module;
attempt to interpret the incoming electrical signals using another software module if the first attempt fails; and
repeat these steps until the incoming electrical signals are interpreted using a suitable software module, the specific software module being said suitable software module.

3. The optoelectronic interface according to claim 1, wherein the processing unit comprises a detection module arranged to analyze target signals from the incoming electrical signals and to produce a detection signal (S_{d}) representative of the specific communication protocol of the specific light signals, and
wherein the processing unit is arranged to select the specific software module on the basis of the detection signal.

4. The optoelectronic interface according to claim 3, further comprising a receive processing component that is connected to an output of the photoreceptor and that is arranged to produce a presence signal having a predefined value when a level of the filtered light signals received by the photoreceptor is greater than a predefined threshold, and wherein the processing unit is arranged to select the specific software module on the basis of a combination of the detection signal and the presence signal.

5. The optoelectronic interface according to claim 3, wherein the detection module comprises at least one detector arranged to detect an energy level of at least one predefined electrical frequency, each predefined electrical frequency being associated with one of the predefined communication protocols.

6. The optoelectronic interface according to claim 3, wherein the detection module is arranged to perform a correlation operation among the target signals and one or more reference signals, each being associated with one of the predefined communication protocols.

7. The optoelectronic interface according to claim 1, wherein a response curve of the bandpass filter comprises, for each carrier signal wavelength associated with a predefined communication protocol, a local maximum covering said carrier signal wavelength.

8. The optoelectronic interface according to claim 7, wherein the response curve comprises, between two successive local maxima, a substantially constant portion having an amplitude substantially equal to that of the local maxima.

9. The optoelectronic interface according to claim 1, further comprising:
a light source arranged to emit outgoing light signals on the optical fibre; a coupling element; and
a beam splitter positioned between the optical fibre on the one hand, and the light source and the photoreceptor on the other hand,
wherein the light source, the photoreceptor, the coupling element, the beam splitter and the bandpass filter are integrated in a single optoelectronic component.

10. The optoelectronic interface according to claim 1, further comprising:
a light source; arranged to emit outgoing light signals on the optical fibre;
a coupling element; and
a beam splitter positioned between the optical fibre on the one hand, and the light source and the photoreceptor on the other hand; and
a Bragg grating, which forms the bandpass filter, and an insulator, the Bragg grating and the insulator being located outside and upstream of said optoelectronic component,
wherein the light source, the photoreceptor, the coupling element and the beam splitter are integrated in the same optoelectronic component.

11. An apparatus including an optoelectronic interface according to claim 1.

12. The apparatus according to claim 11, the apparatus being an internet gateway arranged to be connected to a passive optical network (PON).

13. A configuration method carried out in a processing unit of an optoelectronic interface according to claim 1 and comprising:
acquiring the incoming electrical signals;
selecting a specific software module associated with the specific communication protocol among a plurality of different software modules, each associated with one of the predefined communication protocols; and
interpreting the incoming electrical signals using said specific software module.

14. (canceled)

15. A non-transitory, computer-readable storage medium on which a computer program comprising instructions that cause a processing unit of the optoelectronic interface to execute the configuration method according to claim 13 is stored.
